(19) United States
(12) Patent Application Publication
(10) Pub. No.: US 2006/0229937 A1
(43) Pub. Date: Oct. 12, 2006

(54) Method for retaining a customer at a dealership

(76) Inventor: Douglas R. Manley, Belleville, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 11/101,853

(22) Filed: Apr. 8, 2005

(51) Int. Cl. G06Q 30/00

(52) U.S. Cl. 705/14

(57) ABSTRACT

A method for retaining a customer at a dealership is disclosed. The method includes establishing a customer account when the customer makes a first purchase from the dealership. Each time the customer has a service performed at the dealership, the customer is awarded a rebate to his/her customer account. The customer is allowed to redeem, assign, and/or forfeit the rebate within a predetermined time period. The rebate may be used towards a purchase or lease from the dealership.

### BACKGROUND

The present disclosure pertains generally to methods for retaining customers, and more particularly to methods for dealerships to retain customers.

Generally, many marketing and advertising dollars are spent to bring in new business. However, in some instances, this may be about five times more costly than marketing to current customers. In business today, and especially in the business of selling cars and other motor vehicles, customers often expect a rebate or reward for making a relatively large purchase or lease. Following the theory of supply and demand, if customers expect rebates and rewards, sellers will offer such rebates and rewards. Further, businesses often rely on the loyalty of customers for repeat business. However, with the variety of incentive programs from which customers may select, businesses often struggle to maintain current customers.

As such, it would be desirable to provide a method for dealerships to retain their current customers.

### SUMMARY

A method for retaining a customer at a dealership is disclosed. The method includes establishing a customer account when the customer makes a first purchase from the dealership. Each time the customer has a service performed at the dealership, the customer is awarded a rebate to his/her customer account. The customer is allowed to redeem, assign, and/or forfeit the rebate within a predetermined time period. The rebate may be used towards a purchase or lease from the dealership.

### BRIEF DESCRIPTION OF THE DRAWINGS

Objects, features and advantages of embodiments of the present invention will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is a flow diagram depicting various embodiments of the method;

FIG. 2 is an embodiment of a statement depicting a customer's rebate dollars earned over a period of time;

FIG. 3 is an embodiment of a redemption form; and

FIG. 4 is an embodiment of an assignment form.

### DETAILED DESCRIPTION

Embodiment(s) of the method disclosed herein provide a way for dealerships to retain current customers and/or to obtain and then retain new customers using a rebate system. Further, embodiments of the method advantageously allow a dealership to manage the rebate system in-house or outsource the management of the system to an outside vendor. Still further, embodiments of the method allow the dealership to entice current or new customers to spend money for the dealership's services by offering customers a substantially automatic rebate with each service purchase. The rebate may be used instantaneously or may be accrued over a predetermined time. Further, embodiments of the method include that the rebate may be used toward the purchase or lease of a new or used vehicle from the dealership.

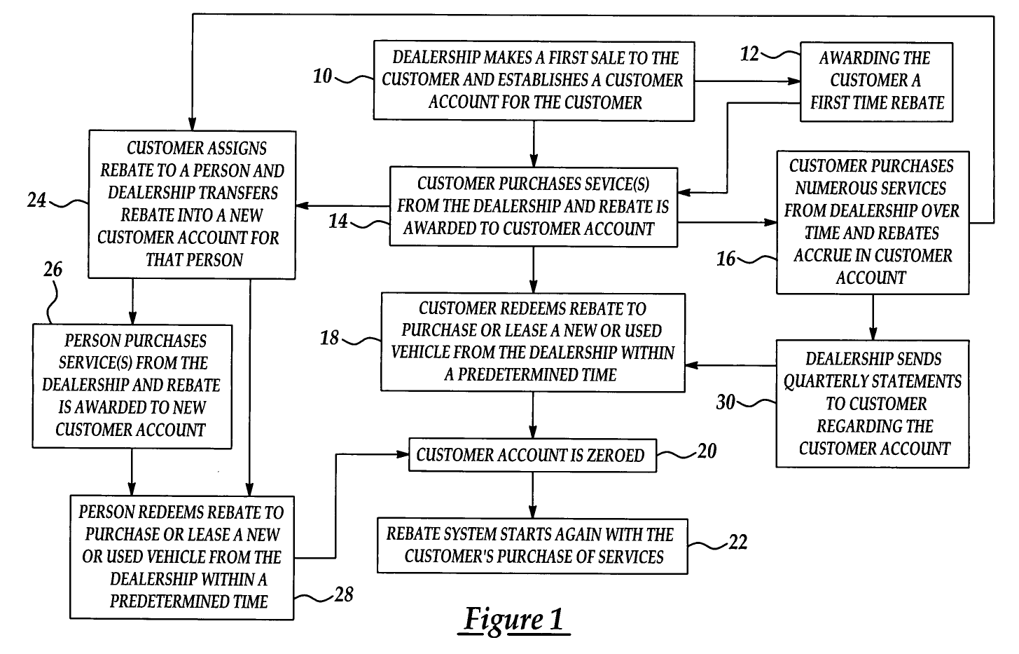

Referring now to FIG. 1, embodiments of the method are disclosed. Dealerships, and in particular those dealerships that sell vehicles and offer repair and/or maintenance services to customers, may use embodiments of the method to obtain and retain customers. Non-limitative examples of such dealerships include automobile dealerships, boat dealerships, snowmobile dealerships, individual watercraft dealerships (for example, Jet Ski® brand recreational watercraft), motorcycle dealerships, recreational vehicle dealerships, and combinations thereof.

In an embodiment, a customer makes an initial, or first, purchase from the dealership, and the dealership establishes a customer account for that customer, as depicted at reference numeral 10. The initial purchase may include new vehicles, used vehicles, services performed on a vehicle, parts for a vehicle, and/or combinations thereof.

In order to entice new customers to make such a first purchase, the dealership may optionally offer a “first time visit” rebate, as depicted at reference numeral 12. It is to be understood that the “first time visit” rebate may be applied to this initial purchase and/or may be applied upon renewal of the customer account, which is discussed in further detail hereinbelow. The “first time visit” rebate may be the total price of the first purchase, or it may be any predetermined amount or percentage of the price of the purchase. The “first time visit” rebate is awarded substantially instantaneously and is transferred into the customer account.

A customer's account is unique to that particular customer and may also be unique to the particular vehicle that the customer has serviced. In an embodiment, a customer who has two different vehicles serviced at the dealership has two separate customer accounts, one for each vehicle. The dealership may use various parameters, such as the customer's personal or identifying information to distinguish one customer account from another customer account. In an embodiment, the customer's name and the vehicle identification number (VIN) are used to identify a particular account and to match it with the customer. It is to be understood that upon establishing the customer account, the dealership enters the identifying information into any suitable filing system (a non-limitative example of which includes a computerized filing system) where it is stored.

As vehicle ownership and customer personal information may change, it is to be understood that the customer accounts may be maintained and updated periodically. The maintenance of the customer accounts may be handled within the dealership or may be outsourced to an outside vendor. In an embodiment in which the customer accounts are managed in-house, the dealership employees update information and communicate with customers periodically. In an embodiment in which the customer accounts are managed by an outside vendor, the outside vendor may obtain the sales and personal data from the dealership (one non-limitative example of obtaining information may be by downloading such information from the dealership's computer system), and then may update the accounts upon receipt of such information from the dealership.

In an embodiment of the method, once a customer has established an account, the customer may return to the dealership, and purchase services from the dealership, as depicted at reference numeral 14. As defined herein, the services may include purchase of parts, routine maintenance, repairs to the vehicle, and/or combinations thereof. Upon purchasing a service from the dealership, the customer is awarded a rebate that is transferred to the customer account within a predetermined time frame. This predetermined time frame may range from substantially instantaneously to within a reasonable period of time after the service is purchased (for example within one or two days to several weeks/month(s)). The rebate is based upon a predetermined percentage of the price of the total service cost, including parts and/or labor. In a non-limitative example, the rebate is about 20% of the price of the services performed. It is to be understood that the customer may not independently contribute to the account without purchasing some service from the dealership.

Each time the customer has a service performed at the dealership, he is awarded a rebate based on that particular service purchase. As a customer may not desire to redeem the rebate upon receiving it, the rebate may be transferred to the customer's account. If the customer has his or her vehicle serviced numerous times, the rebates may accrue in the customer account for a time not exceeding a predetermined period, as depicted at reference numeral 16.

Within the predetermined time period, the customer is allowed to redeem, assign, and/or forfeit the rebate, as depicted at reference numeral 18. In an embodiment, the predetermined time period extends to five years from the establishment of the customer's account. If the predetermined time period passes, and the customer does not redeem or assign the rebate, he forfeits the rebate(s).

The rebate is redeemed for the purchase or lease of a new or used vehicle from the dealership. It is to be understood that the rebate is funded by the dealership, in part, to induce the customer to return to that particular dealership to purchase or lease their next vehicle. After the customer redeems their rebate(s), the customer account is zeroed, as shown at reference numeral 20. The customer account remains at zero until the customer again purchases services from the dealership. At this time, a new “first time visit” rebate may be awarded, and the service rebate system begins again, as shown at reference numeral 22.

In an alternate embodiment, the customer may assign some or all of his or her rebate(s) to another person (i.e. the assignee), as shown at reference numeral 24. It is to be understood that the assignment may take place at any time within the predetermined time period. In an embodiment, assigning the rebate(s) may be accomplished by having the customer sign a writing that indicates the person to whom the rebate(s) is being transferred. The writing is submitted and accepted by the dealership, which then establishes a customer account for the assignee. The assigned portion of the original customer's rebate(s) are transferred into the assignee's customer account.

The original customer may transfer all or a portion of the rebate available in his customer account. In an embodiment, the customer redeems a portion of the rebate and assigns the remaining portion of the rebate to another person.

It is to be understood that the assignee is bound by the time period by which the original customer was bound. For example, if the original customer's predetermined time period is to expire within a week of the assignment, then the assignee's acquired rebate will also expire within a week of the assignment.

The assignee may also add to his newly acquired rebate(s) by having services performed at the dealership, shown at reference numeral 26. The assignee may redeem (as at reference numeral 28), assign, or forfeit the rebate(s) just as if he were the original customer.

In an embodiment, if a customer (who has a customer account) transfers ownership of the vehicle that corresponds with that customer account, the dealership liquidates the customer account. It is to be understood that the account may be liquidated by redeeming the rebate(s), assigning the rebate(s), and/or forfeiting the rebate(s).

It is to be understood that, in an alternate embodiment, the dealership (or outside vendor if used) may issue (e.g. by mail, email, and/or the like) monthly, quarterly, mid-year, and/or annual statements (or any other periodic statement, e.g. bimonthly, etc.) that outline the customer's service record, rebate balance and/or time remaining to redeem or assign the rebate, as depicted at reference numeral 30. The dealership may optionally allow the customers to view their account information via the Internet. Still further, the dealership may distribute marketing materials, such as coupons for services and/or other purchases at the dealership, with the statements.

It is to be understood that the dealership may also include limitations on the rebates. One non-limitative example of such a limitation includes that two customers may not pool their respective rebates and use them toward the purchase or lease of a single new or used vehicle. Another non-limitative example of such a limitation includes that one customer may not pool rebates earned from more than one vehicle into a single customer account and then use them toward the purchase or lease of a single new or used vehicle.

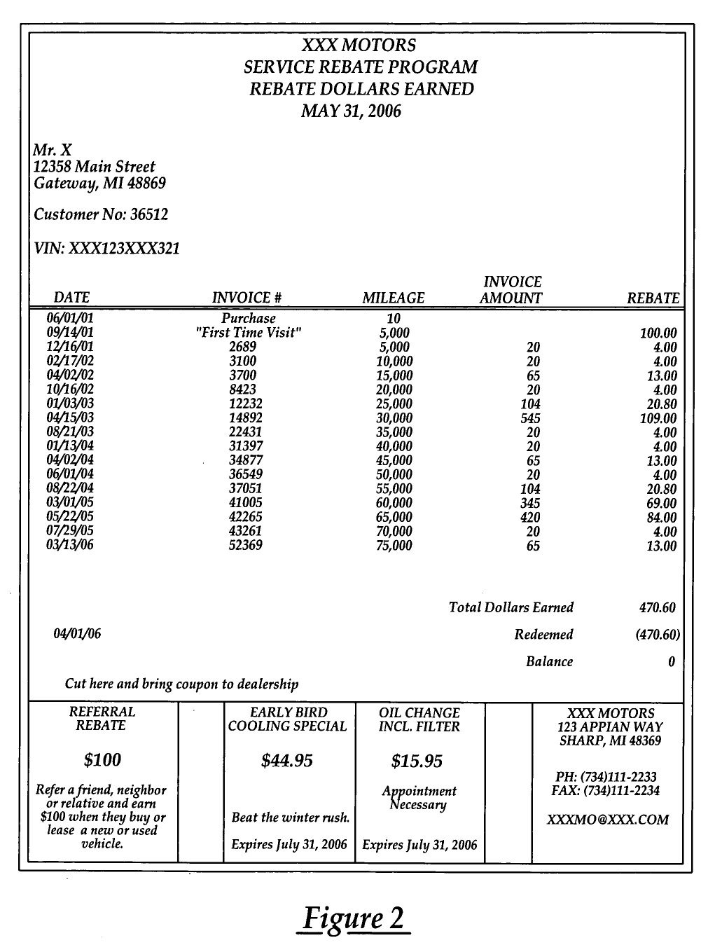

Referring now to FIG. 2, there is depicted a non-limitative example of a customer account record over the predetermined time period of five years. As shown, each time Mr. X serviced his car at XXX Motors, he generally received about a 20% rebate of the total service price. Mr. X accrued his rebates in his account until he redeemed them for the purchase or lease of another vehicle.

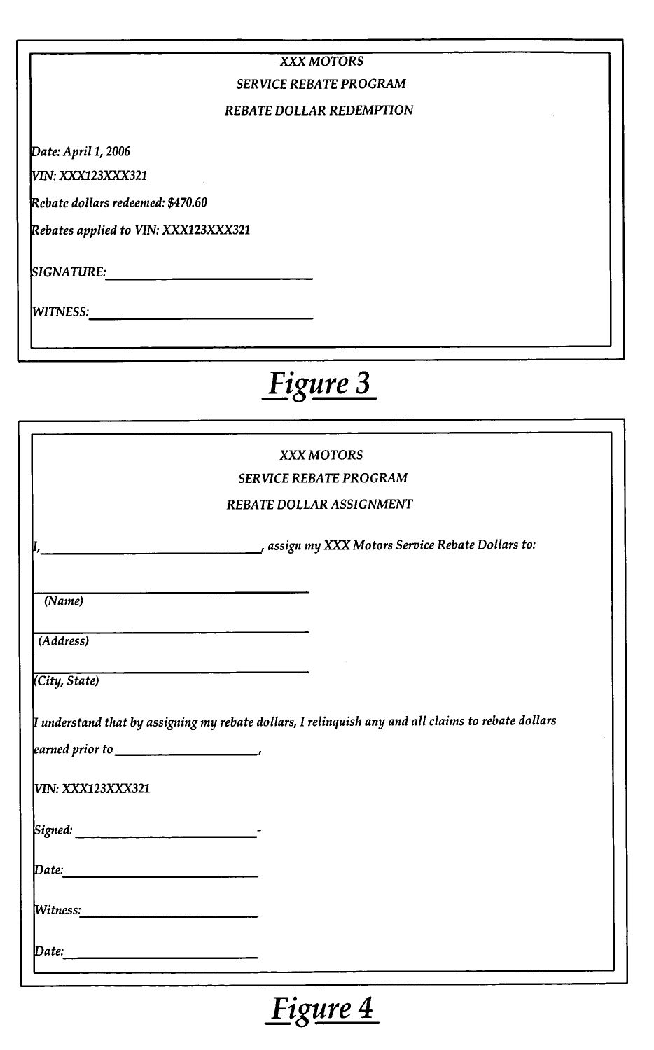

FIG. 3 depicts a non-limitative example of a rebate redemption form. When a customer desires to redeem his rebate, he signs, generally in the presence of a witness, the rebate form and submits it to the dealership who applies the rebate to the customer's purchase or lease, and zeros his account.

FIG. 4 is a non-limitative example of an assignment form. When a customer desires to assign his rebate, he fills in, signs, and submits the form to the dealership, which approves the transfer of the rebate.

Embodiment(s) of the method include, but are not limited to the following advantages. The rebate system allows a dealership to retain current customers and/or to obtain and then retain new customers. By offering customers a substantially automatic rebate with each service purchase, the method advantageously allows the dealership to entice current or new customers to spend money for the dealership's services. Still further, the rebate is redeemable for the purchase or lease of a vehicle from the same dealership that awarded the rebate, thereby substantially enhancing the chances that the customer will continue to purchase and/or lease from the dealership. As such, the customer receives more than a discounted price, he receives money back from prior purchases that may be used toward another purchase or lease.

While several embodiments have been described in detail, it will be apparent to those skilled in the art that the disclosed embodiments may be modified. Therefore, the foregoing description is to be considered exemplary rather than limiting.

What is claimed is:

1. A method for retaining a customer at a dealership, the method comprising:
establishing a customer account upon a first purchase by the customer from the dealership;
awarding a rebate to the customer account each time the customer has a service performed at the dealership; and
allowing the customer to at least one of redeem, assign, and forfeit the rebate within a predetermined time period, wherein the rebate may be used toward a purchase or a lease from the dealership.

2. The method as defined in claim 1 wherein the rebate is based on a predetermined amount or percentage of a price of at least one of parts and labor included in the service performed.

3. The method as defined in claim 1, further comprising accruing the awarded rebates in the customer account for a time not exceeding the predetermined time period.

4. The method as defined in claim 3 wherein the predetermined time period is five years from the establishment of the customer account.

5. The method as defined in claim 1 wherein the dealership is at least one of automobile dealerships, boat dealerships, snowmobile dealerships, individual watercraft dealerships, motorcycle dealerships, recreational vehicle dealerships, and combinations thereof.

6. The method as defined in claim 1 wherein the predetermined time period ranges from a time when a first rebate is awarded to five years from the establishment of the customer account.

7. The method as defined in claim 1, further comprising sending the customer a quarterly statement including a balance of the rebate.

8. The method as defined in claim 1, further comprising managing the customer account.

9. The method as defined in claim 8 wherein managing the customer account is accomplished by employees of the dealership or by an outside vendor.

10. The method as defined in claim 1 wherein assigning the rebate is accomplished by the customer signing a writing indicating a person to whom the rebate is being transferred, and submitting the writing to the dealership.

11. The method as defined in claim 1 wherein the customer account includes customer-identifying information, and wherein the method further comprises updating the customer-identifying information.

12. The method as defined in claim 1 wherein establishing the customer account may be accomplished when the customer purchases at least one of a new vehicle, a used vehicle, a service performed upon a vehicle, a part for a vehicle, and combinations thereof.

13. The method as defined in claim 1, further comprising awarding a first time rebate when the customer makes the first purchase from the dealership.

14. The method as defined in claim 1 wherein the customer redeems the rebate and the method further comprises:
zeroing the customer account after the customer redeems the rebate toward the purchase or the lease;
awarding a new rebate to the customer account each time the customer has a service performed at the dealership; and
allowing the customer to at least one of redeem, assign, and forfeit the new rebate within a new predetermined time period, wherein the new rebate may be used toward an other purchase or an other lease from the dealership.

15. The method as defined in claim 1 wherein the customer assigns the rebate to a person, and the method further comprises:
transferring the rebate to a new customer account for the person; and
allowing the person to at least one of redeem, assign, and forfeit the rebate within the predetermined time period, wherein the rebate may be used toward the purchase or the lease from the dealership.

16. The method as defined in claim 15 wherein prior to allowing the person to at least one of redeem, assign, and forfeit the rebate, the method further comprises accruing the awarded rebates in the new customer account for a time not exceeding the predetermined time period.

17. The method as defined in claim 1 wherein the awarding of the rebate occurs substantially instantaneously.

18. A method for obtaining and retaining a customer at a dealership, the method comprising:
offering the customer a first time visit rebate when the customer makes a first purchase from the dealership;
establishing a customer account when the first purchase is made;
awarding a rebate to the customer account each time the customer has a service performed at the dealership; and
allowing the customer to at least one of redeem, assign, and forfeit the rebate within a predetermined time period, wherein the rebate may be used toward a purchase or lease from the dealership.

19. The method as defined in claim 18 wherein the rebate is based on a predetermined amount or percentage of a price of at least one of parts and labor included in the service performed.

20. The method as defined in claim 18, further comprising accruing the awarded rebates in the customer account for a time not exceeding the predetermined time period.

21. The method as defined in claim 18 wherein the predetermined time period is five years from the establishment of the customer account.

22. The method as defined in claim 18 wherein the dealership is at least one of automobile dealerships, boat dealerships, snowmobile dealerships, individual watercraft dealerships, motorcycle dealerships, recreational vehicle dealerships, and combinations thereof.

23. The method as defined in claim 18, further comprising managing the customer account, and wherein the managing is accomplished by employees of the dealership or by an outside vendor.

24. The method as defined in claim 18 wherein establishing the customer account may be accomplished when the customer's first purchase is at least one of a new vehicle, a used vehicle, a service performed upon a vehicle, a part for a vehicle, and combinations thereof.

25. The method as defined in claim 18 wherein the customer redeems the rebate and the method further comprises:
zeroing the customer account after the customer redeems the rebate toward the purchase or the lease;
awarding a new rebate to the customer account each time the customer has a service performed at the dealership; and
allowing the customer to at least one of redeem, assign, and forfeit the new rebate within a new predetermined time period, wherein the new rebate may be used toward an other purchase or an other lease from the dealership.

26. The method as defined in claim 18 wherein the customer assigns the rebate to the person, and the method further comprises:
transferring the rebate to a new customer account for the person; and
allowing the person to at least one of redeem, assign, and forfeit the rebate within the predetermined time period, wherein the rebate may be used toward the purchase or the lease from the dealership.

27. The method as defined in claim 26 wherein prior to allowing the person to at least one of redeem, assign, and forfeit the rebate, the method further comprises accruing the awarded rebates in the new customer account for a time not exceeding the predetermined time period.
